(19) United States
(12) Patent Application Publication
(10) Pub. No.: US 2005/0081843 A1
(43) Pub. Date: Apr. 21, 2005

(54) Egg cooker

(76) Inventor: Hendrik Oostenwald Johannes Lamprecht, Durban (ZA)

Correspondence Address: YOUNG & THOMPSON, 745 SOUTH 23RD STREET, 2ND FLOOR, ARLINGTON, VA, 22202, US

(21) Appl. No.: 10/503,718

(22) PCT Filed: Feb. 5, 2003
(86) PCT No.: PCT/ZA03/00015

(30) Foreign Application Priority Data
Feb. 6, 2002 (ZA) 2002/1022

(51) Int. Cl. A47J 27/026

(52) U.S. Cl. 126/391.1

(57) ABSTRACT

An apparatus (10) for rapidly cooking comestibles and particular eggs, comprises one or more receptacles (20) for the eggs, a bath (12) containing cooking fluid to heat the receptacle from below and a dispenser (26) for applying heating cooking fluid to the receptacles and comestibles from above, the heated cooking fluid being pumped to the dispenser by pump (24).

### TECHNICAL FIELD OF THE INVENTION

This invention relates to an apparatus for cooking eggs and the like, and in particular for preparing fried eggs.

### BACKGROUND ART

Frying of eggs is not an easy task and even experienced chefs have difficulty in consistently producing eggs to the satisfaction of consumers thereof.

One of the main problems associated with the frying of eggs is the difficulty in maintaining a temperature at which the oil or fat used fries the egg without crisping it or having it adhere t the cooking vessel. Ideally a level of the hot oil or fat must be maintained in the vessel to permit covering partially or periodically, the upper portions of the egg.

Bearing in mind that in traditional egg frying, it is the hot oil or fat itself and not the heat of the pan that cooks the egg, it has come to the applicant's attention that if hot oil or fat is applied to the upper surface of the egg, it cooks substantially quicker and crisping of the underside can be avoided, unless particularly desired.

This may be achieved in prior art methods by maintaining a substantial volume or level of hot oil or fat in the vessel, but this leads to oily, greasy or fatty eggs which are regarded as being unhealthy. Apart from this aspect, it is also difficult to safely maintain the oil at the required temperature. The “healthiest” fried eggs are perhaps produced using a hot plate as no oil is required, but this method is slow and unsuitable for large volumes. Increasing heat burns the egg white and renders the eggs aesthetically unappealing to most.

The difficulties of egg frying are obviously exacerbated for chefs in restaurant or fast food kitchens where large volumes of fried eggs must be produced continuously.

Fast food restaurants are known to deep fry eggs in order to keep up with volume demand by making use of the principle that if the egg is cooked from all sides, it will cook more rapidly. This method is however extremely unhealthy and further often produces eggs which are aesthetical unappealing. In addition, it may be difficult to consistently produce eggs cooked to specific requirements.

It is therefore an object of this invention to provide an apparatus which, in its simplest form, will assist in rapidly frying several eggs to the required extent, and which may be modified and automated for greater volumes. It is a further object of the invention to provide a healthier method for fried egg preparation.

Yet a further object of the invention is to provide an apparatus which may also be used for poaching eggs.

### DISCLOSURE OF THE INVENTION

According to the invention, an apparatus for cooking comestibles and in particular eggs, includes one or more receptacles for the comestibles; and
a bath containing cooking fluid and having means for heating the cooking fluid;
the receptacles comprising heat conductive material and being heated from the base thereof by the cooking fluid;
the level of the cooking fluid being maintained below the rim(s) of the receptacles.

In the simplest form of the invention, the bath may comprise an electric frying pan filled to a predetermined level with cooking oil, with the receptacle comprising a tray floating on the oil surface and including a plurality of concave or dished depressions for the eggs. Oil may be ladled onto the eggs to speed up cooking. In the preferred form, a floating tray is provided with apertures for receiving individual dishes which sit in the apertures in contact with the oil.

The principle of operation is that it is not the oil itself which fries the eggs, but rather the heated tray. As mentioned above, the process may be accelerated by pouring hot oil onto the upper side of the eggs.

Therefor in a modification of this invention, a dispensing element is provided which is locatable above the receptacle(s) and the apparatus further includes means for transferring cooking fluid from the bath to the dispensing element.

In the preferred form of the invention, the means for transferring the cooking fluid comprises a pump, the pump being connected to the dispensing element by means of piping. The pump is preferably a centrifugal pump adapted to provide variable flow of cooking fluid. The bath is preferably insulated in order to retain heat.

Also in the preferred form of the invention the bath comprises a circular housing adapted to receive a concave tray including a heating element, which may be integrally moulded therein. In the preferred form, the heating element is located beneath the concave tray. The concave tray includes a central vertical shaft upon which a carousel is mounted. The shaft includes a flange upon which the carousel rests at the appropriate height.

The carousel may comprise a flat tray with a peripheral lip, the tray including a plurality of openings for receiving egg dishes. The egg dishes comprise circular concave dishes and include a central circular depression. The bases of the egg dishes may contact the oil directly, but in the preferred form, the openings are sealed by means of a sheet of highly heat-conductive material. Typically, a sheet of steel of thickness 1 mm to 2 mm is used.

The egg dishes themselves are preferably 0,3 to 0,5 mm in thickness and may be teflon coated. Rests may be provided on the carousel upon which the egg dishes are seated. The egg dishes preferably include lugs to assist in handling and removal of the dishes.

In an alternative form, the carousel may be dished to receive individual egg dishes.

The carousel is rotatable by means of small motor and includes a predetermined number of catches spaced apart about the periphery of the carousel to temporarily stop rotation of the carousel to enable the dispensing means to dispense hot cooking fluid onto the eggs. Integral paddles are provided on the base of the carousel to ensure even heat distribution in the heating tray.

The carousel preferably also includes around the base of the central vertical shaft, an aperture through which oil drains into the bath below. A sieve element may be provided which is adapted to fit over the aperture and if required, an appropriately shaped piece of filter paper may be provided therebelow.

The egg dishes preferably comprise six pairs of dishes, each pair being connected. The pairs are each located at an angle of 45 degrees relative to a radius from the shaft of the carousel, and relative to each other. This angle has been found to be optimally advantageous from a spacing perspective, a ease of handling perspective and thirdly permitting efficient operation of the dispensing element.

In the preferred form, the dispensing element comprises a tip-tray into which heated cooking fluid is pumped, the tray being adapted to periodically tip the heated oil onto a pair of receptacles below.

The tray is preferably pivotable under the influence of gravity between a non-dispensing or loading position and a dispensing position.

The tray includes a transverse bar which pivotally engages a pair of cheek formations either side of an opening in a mounting plate attachable to the central vertical shaft of the heating tray. The opening is dimensioned to permit the tip-tray to dispense therethrough.

The tip-tray includes a raised rim along the rear and sides, and an angled lip at the front thereof. The tray is compartmentalised by a low transverse wall into front and rear compartments.

In operation, when oil is pumped from the heating bath into the rear compartment of the tip-tray, the compartment fills first maintaining the tray in the level or non-dispensing position. Once a volume of oil greater than the volume (γ) of the compartment has been pumped thereinto, the oil overflows into the front compartment which has a volume (χ). Once the volume of oil in the front compartment reaches volume (χ), the tip-tray tips and dispenses the hot oil onto a pair of eggs in egg dishes below.

The continued flow of oil into the rear compartment returns the tip-tray to the non-dispensing position.

The dimensions of the tip-tray are a product of several factors. Firstly the width of the tip-tray is greater than or equal to the width of a pair of joined egg dishes.

The dimensions are calculated to permit complete cooking the white of an egg in one or two tipping operations. This is determined by the volume of hot oil required to achieve this. The length is therefore determined according to the appropriate weight of oil in the front compartment (volume χ) required to overcome the weight of oil in the full rear compartment (volume γ).

The volume (χ) of the rear compartment is determined by the capacity of the egg frying apparatus. The applicant has determined that the height of the transverse wall between the compartments should be 5 to 20% of the length of the rear compartment.

The angle at which the tip-tray is set according to the volume of oil required. The greater the volume of oil, the lower the angle of tilt and the fewer the number of tipping operations required. It is however preferred that more tipping operations are used and therefor lower volumes of oil may be tipped. A less horizontal angle is therefor preferred.

The oil from the bath is pumped via two lines. The first line empties into the tipping-tray and includes a valve for controlling flow into the tray. This in turn controls the number of times the tip-tray empties in a single revolution of the carousel.

The second line is the overflow and circulating line which empties directly back into the heating tray diametrically opposite the pump and assists the paddles of the carousel in circulating the oil.

In the preferred form, a well for cooking fluid is located below the pump to ensure that loss of oil during cooking does not lead to the pump running dry. This feature is of even greater importance when the apparatus is used to poach eggs due to the rate of operation of water as the cooking fluid.

When water is the cooking fluid, a removable cover element may be provided to retain steam formed and reduce the rate of evaporation

A draining tray is may also be provided.

### BRIEF DESCRIPTION OF THE DRAWINGS

The preferred embodiment of the invention is described below with regard to the accompanying drawings in which:

FIG. 1 is an isometric front view of the apparatus according to the invention;

FIG. 2 is an isometric rear view of the apparatus;

FIG. 3 is an exploded isometric view of the components of the apparatus;

FIG. 4 is an isometric front view of the apparatus with the cover element partially cut-away;

FIG. 5 is an isometric views of the carousel;

FIG. 6 is an isometric view of the underside of the carousel;

FIG. 7 is an isometric view of the bath;

FIG. 8 is an isometric view of the tip-tray and supporting frame; and

FIG. 9 is a similar view of the cooking receptacles.

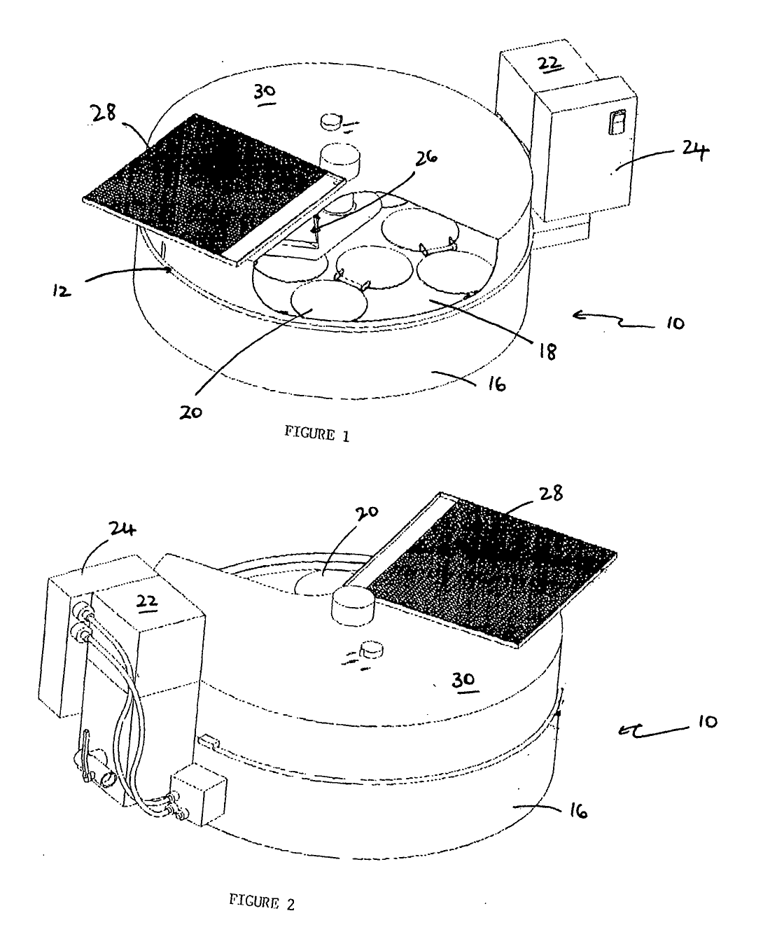

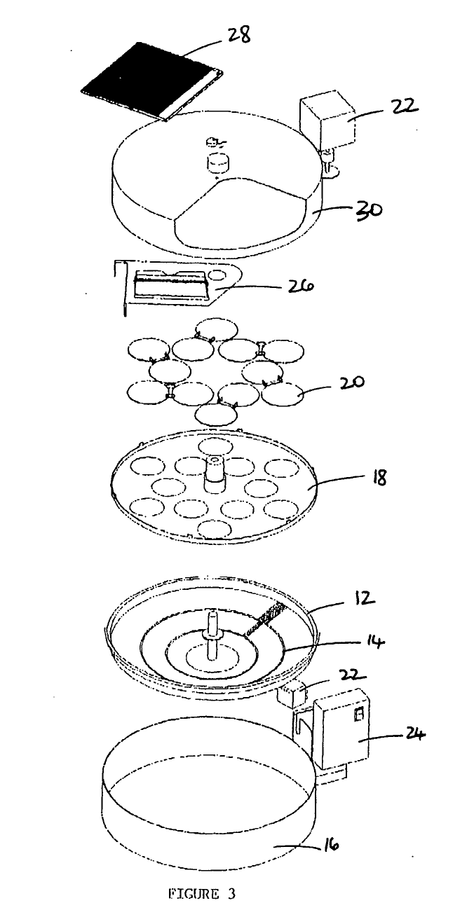

### BEST MODE FOR CARRYING OUT THE INVENTION

In the drawings and egg cooking apparatus 10 comprises a bath 12 of cooking fluid heated by an element 14 and supported on a circular base 16. A carousal 18 has a number of receptacles pairs 20 for eggs is rotatable in the bath by means of motor 22. Cooking fluid is pumped by means of pump 24 from the bath into a trip-tray 26 which, when full pours hot cooking fluid over the eggs in receptacle pairs as they stop momentarily below the tip-tray.

This enables the eggs to be cooked above and below the hot oil or hot water, depending on whether fried or poached eggs are required. In this manner, two eggs may be cooked every 25 seconds.

Cooked eggs may be placed on drain elements 28 which is mounted on the cover 30.

As seen in FIG. 7, the bath 12 has integrally moulded heating element 14. In the embodiment shown the element, is moulded into the upper surface of the bath but it is in fact preferable that it should be located on the under surface thereof. The bath has a central vertical shaft 32 with a flange 34 upon which the carousel is mounted.

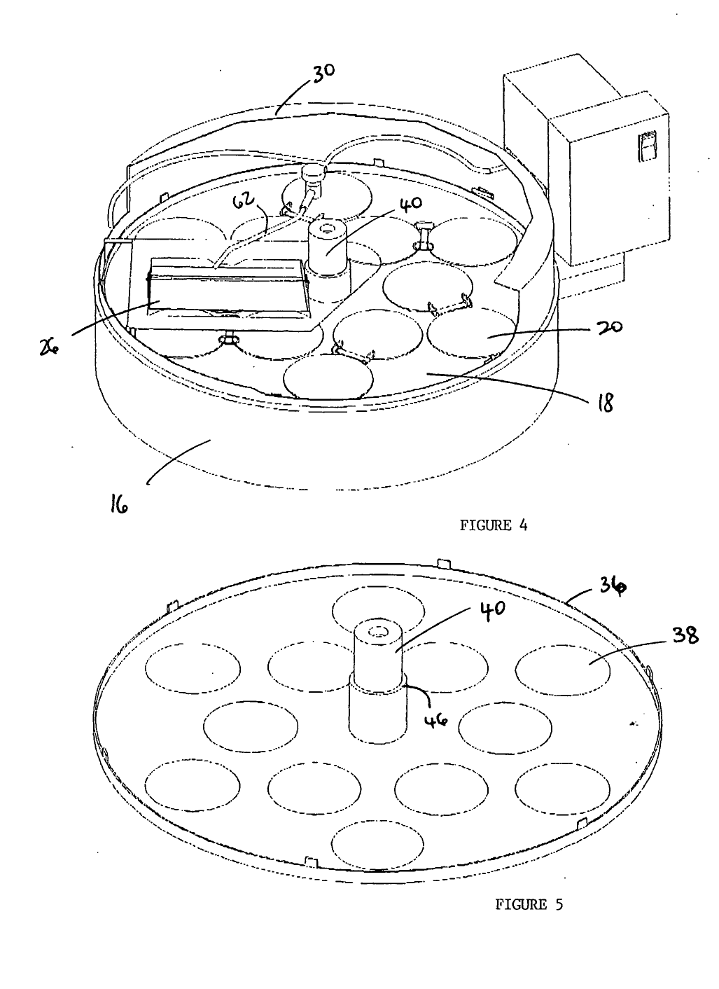

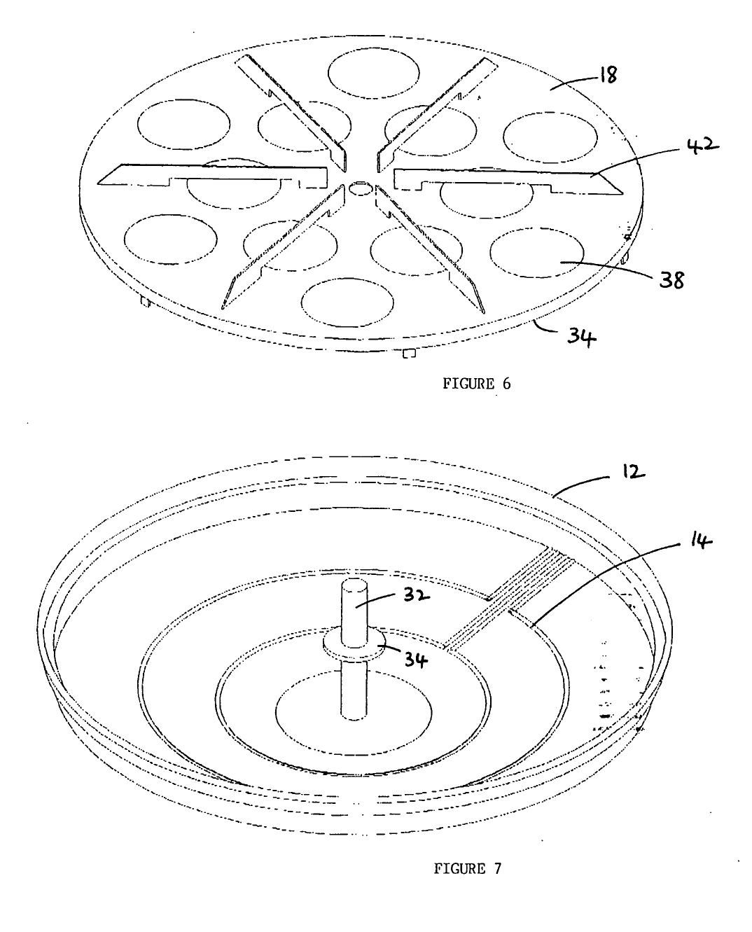

The carrousel 18 (FIG. 5 and 6) comprises a flat tray with a peripheral lip 36 and twelve circular openings 38 in which the egg-receptacles sit. Six pairs of openings are provided for six pairs of receptacles and are located at an angle of approximately 45 degrees relative to a radius from the central mounting shaft 40 of the carousel.

The egg receptacles (FIG. 9) are circular concave dislikes 20 which have a central circular depression (not shown). The bases of the dishes sit in the openings, protruding to contact the cooking fluid in the bath.

The base of the carousel may include paddles 42 to assist in circulating the oil for even heat distribution.

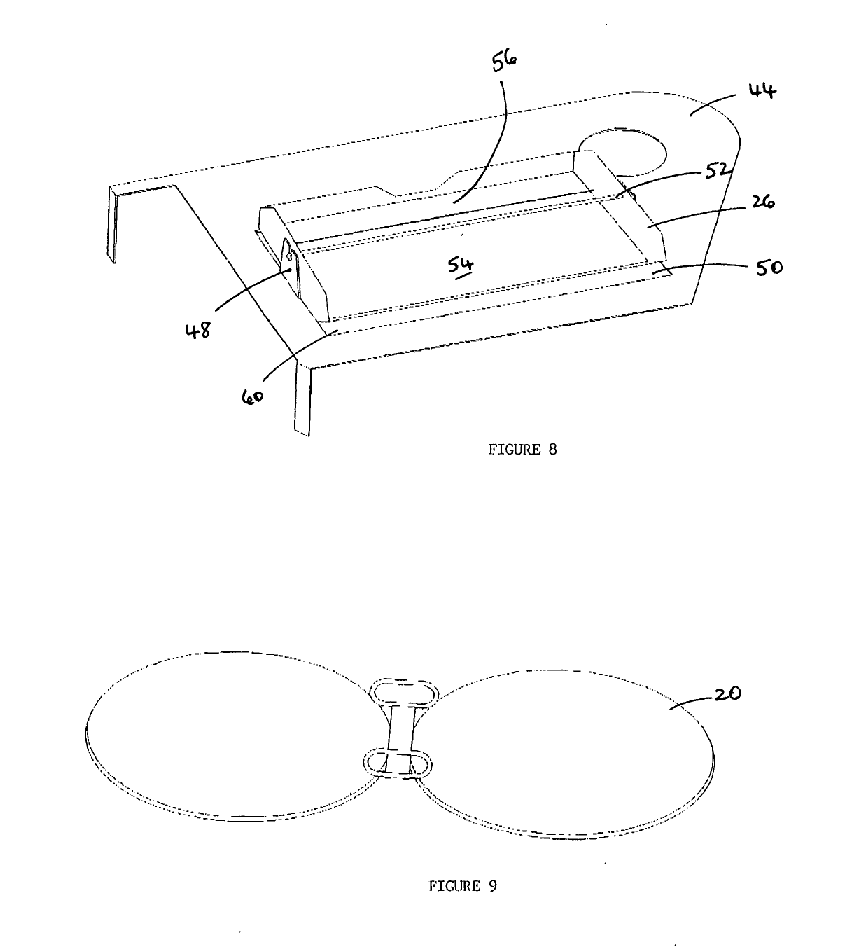

The tip-tray 26 (FIG. 8) is mounted on a mounting plate 44 which is in turn mounted atop the ridge 46 on the mounting element 40 of the carousel. The mounting plate is fixed to the side of the apparatus and does not rotate with the carousel.

The mounting plate includes a pair of cheek formations 48 either side of a hole 50 is the plate through which the tip-tray dispenses. The tip-tray 26 includes a transverse bar 52 which engages the cheek formations pivotally. The tray is divided into front 54 and rear 56 compartments by low wall 58 with the front compartment having an angled lip 60.

In operation, cooking fluid is pumped from the bath into the rear compartment 56 via line 62. Once the rear compartment is full, it overflows into the front compartment until there is sufficient fluid in the front compartment to trip the tray under the influence of gravity, and dump the fluid onto the egg dishes waiting below. The continued flow of fluid into the rear compartment returns the tray to the horizontal position.

The dispensed fluid drains back into the bath through the openings 38 to an extent, but largely through a central drain (not shown) around the base of the shaft 40. A sieve may be provided to filter debris.

1-32. (canceled)

33. An apparatus for cooking comestibles and in particular eggs, includes one or more heat conductive receptacles for comestibles, a bath for containing cooking fluid and means for heating the cooking fluid, a dispensing element for periodically applying heated cooking fluid to the contents of the receptacle from above, and means for transferring cooking fluid from the bath to the dispensing element, characterised in that the receptacles are movable about the bath in a predetermined pathway to ensure periodic application of cooking fluid from the dispensing element.

34. An apparatus according to claim 33 characterised in that a dispensing element is set to dispense only when one or more receptacles is located below the dispensing element.

35. An apparatus according to claim 34 characterised in that the means for transferring the cooking fluid comprises a variable flow rate centrifugal pump.

36. An apparatus according to claim 33 characterised in that the bath is insulated.

37. An apparatus according to claim 33 in which the bath comprises a circular housing characterised in that it is adapted to receive a concave tray including a heating element.

38. An apparatus according to claim 37 characterised in that the heating element is integrally moulded into the tray.

39. An apparatus according to claim 38 characterised in that the heating element is integrally moulded into the underside of the tray.

40. An apparatus according to claim 37 characterised in that the concave tray includes a central vertical shaft upon which a carousel is mounted, the shaft including a flange upon which the carousel rests at the appropriate height.

41. An apparatus according to claim 40 characterised in that the carousel comprises a flat circular tray with a peripheral lip, the tray including a plurality of openings for receiving egg dishes (receptacles).

42. An apparatus according to claim 41 characterised in that the egg dishes comprise circular concave dishes and include a central circular depression.

43. An apparatus according to claim 41 characterised in that the egg dishes contact the cooling fluid directly.

44. An apparatus according to claim 41 characterised in that the openings are sealed by means of a sheet of highly heat-conductive material.

45. An apparatus according to claim 41 characterised in that the egg dishes are teflon coated, and include lugs to assist in handling and removal of the dishes.

46. An apparatus according to claim 41 characterised in that the tray is dished to receive individual egg dishes.

47. An apparatus according to claim 41 characterised in that the six pairs of egg dishes are provided, each pair being connected and being located at an angle of 45 degrees relative to a radius from the shaft of the carousel, and relative to each other.

48. An apparatus according to claim 41 characterised in that the carousel is rotatable by means of small motor and includes a predetermined number of catches spaced apart about the periphery of the carousel to temporarily stop rotation of the carousel to enable the dispensing means to dispense hot cooking fluid onto the eggs.

49. An apparatus according to claim 41 characterised in that the carousel includes integral paddles on the base thereof to ensure even heat distribution in the bath.

50. An apparatus according to claim 40 characterised in that the carousel includes around the base of the central vertical shaft, an aperture through which oil drains into the bath below, a sieve element being provided which is adapted to fit over the aperture.

51. An apparatus according to claim 50 characterised in that a complimentally shaped piece of filter paper is insertable below the sieve element.

52. An apparatus according to claim 34 characterised in that the dispensing element comprises a tip-tray into which heated cooking fluid is pumped, the tray being adapted to periodically tip the heated oil onto a pair of receptacles below.

53. An apparatus according to claim 52 characterised in that the tray is pivotable under the influence of gravity between a non-dispensing or loading position and a dispensing position.

54. An apparatus according to claim 52 characterised in that the tray includes a transverse bar which pivotally engages a pair of cheek formations either side of an opening in a mounting plate attachable to the central vertical shaft of the heating tray, the opening being dimensioned to permit the tip-tray to dispense therethrough.

55. An apparatus according to claim 52 characterised in that the tip-tray includes a raised rim along the rear and sides, and an angled lip at the front thereof, the tray being compartmentalised by a low transverse wall into front and rear compartments.

56. An apparatus according to claim 55 characterised in that the height of the transverse wall between the compartments should be 5 to 20% of the length of the rear compartment.

57. An apparatus according to claim 55 characterised in that the volume of the front compartment is greater than or equal to the volume of the rear compartment.

58. An apparatus according to claim 34 characterised in that the dimensions and angle of the tip-tray are proportionate to the frequency of tipping of the tray and rate of cooking of the comestibles.

59. An apparatus according to claim 35 characterised in that the pump is located above a reservoir of cooking fluid in order to prevent the pump running dry.

60. An apparatus according to claim 33 characterised in that the apparatus includes a draining tray.

61. An apparatus according to claim 33 characterised in that the cooking fluid is oil.

62. An apparatus according to claim 33 characterised in that the cooking fluid is water.

63. An apparatus according to claim 62 characterised in that a removable cover element is provided to retain steam formed and to reduce water loss by evaporation.
